(19) United States
(12) Patent Application Publication
(10) Pub. No.: US 2025/0326670 A1
(43) Pub. Date: Oct. 23, 2025

(54) SELF-CONTAINED HEXAVALENT CHROMIUM PRECIPITATION AND FILTRATION SYSTEM

(71) Applicant: ATEC Water Systems, LLC, Los Angeles, CA (US)

(72) Inventor: Lee Odell, Vancouver, WA (US)

(21) Appl. No.: 18/639,665

(22) Filed: Apr. 18, 2024

(51) Int. Cl. C02F 9/00; B01D 39/20; C02F 1/00; C02F 1/28; C02F 1/70; C02F 1/72; C02F 1/76; C02F 101/22; C02F 103/10

(52) U.S. Cl. CPC C02F 9/00; B01D 39/20; C02F 1/008; C02F 1/004; C02F 1/281; C02F 1/705; C02F 1/727; C02F 1/76; C02F 2101/22; C02F 2103/10; C02F 2303/16

(57) ABSTRACT

A chromium water source can be doped with a reducing agent and an oxidation agent to facilitate reduction of hexavalent chromium to trivalent chromium. Thereafter trivalent chromium can be adsorbed or arrested by a set of post filters. The filtration system is enclosed in a site-delivered or site-manufactured enclosure that can be automatically controlled by an internal controller.

### TECHNICAL FIELD

Embodiments described herein relate to industrial duty water filtration systems and, in particular, to self-contained appliances and systems for removing hexavalent and trivalent chromium from a water source via precipitation.

### BACKGROUND

Trivalent and hexavalent chromium contamination in drinking water poses health risks, including dermatitis, nerve tissue damage, renal and liver damage, and potential links to certain lung and stomach cancers.

Conventional systems for chromium level mitigation are often exclusively residential scale or are otherwise large, expensive, and require significant power and ongoing maintenance and exhibit low water recovery efficiency; conventional systems may not be suitable between residential scale and utility scale. Further, in many cases, conventional systems produce a byproduct of concentrated brine that in many jurisdictions must be handled and disposed of in a regulated manner, further increasing cost and complexity.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a self-contained hexavalent chromium (Cr(VI)) mitigation system as described herein.

FIG. 2 depicts a simplified schematic control diagram of a hexavalent chromium mitigation system as described herein.

FIG. 3 depicts a simplified schematic flow diagram of a self-contained hexavalent chromium mitigation system as described herein.

FIG. 4 depicts a flow chart corresponding to example operations of a method of hexavalent chromium mitigation, as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to water decontamination systems and, in particular, to hexavalent chromium (Cr(VI)) mitigation systems. Systems as described herein can likewise filter high concentrations of trivalent chromium (Cr(III)). Systems and constructions described herein can be leveraged to filter groundwater or other chromium-rich water sources.

As known to a person of skill in the art, certain water sources may be chromium rich. Chromium is a heavy metal contaminant to potable water. Problematically, chromium contamination is often not detectable by taste, odor, or visual inspection. Regular consumption of Cr(VI) contaminated water can lead to long-term health consequences. For example, research suggests a link between long-term Cr(VI) consumption and certain lung and stomach cancers.

Although many concentrations of Cr(III) are not associated with negative health effects, high concentrations are also unsuitable for consumption. Maximum contamination levels (MCLs) for both Cr(III) and Cr(VI) are set by the U.S. Environmental Protection Agency (EPA) and other similar regulatory bodies worldwide. As a result, if a water source to be used for a purpose exceeds MCL for either Cr(III) or Cr(VI), mitigation may not only be advisable, but it may also be required by law.

Problematically, many conventional chromium mitigation techniques are only suitable or economical at residential volumes. Likewise, utility-scale mitigation solutions are often cost effective only at utility scale (and/or with public subsidy), and may not be suitable for midsized industrial use cases or for agricultural, commercial, or multi-tenant residential use cases.

Compounding the foregoing is that chromium contamination of groundwater and surface water is anthropogenic and worsening over time. This increases the need for chromium mitigation in physical more locations, operable at many different service volume levels, to filter water for more users and use cases.

More simply, systems mitigating both Cr(III) and Cr(VI) in water supplies between utility scale and residential scale is necessary. As noted above, many residential filtering techniques cannot be economically scaled and many utility-scale installation costs cannot be justified for lower volume sites.

Generally and broadly, chromium levels have been conventionally reduced in several ways: (1) blending, (2) water removal techniques, (3) filtration techniques, (4) microbial degradation, (5) nanomaterial adsorption, or (6) chemical precipitation.

Blending is a conventional technique for reducing concentration of any individual contaminant below MCL in which a high contaminant concentration water source is combined, in suitable proportion, with a low contaminant water source in order to dilute overall contaminant concentration below standard MCL. However, blending is often not suitable for treating many water sources, because low-chromium water is expressly required as an input (whether sourced locally or transported on site).

Further, blending systems often require dedicated storage, plumbing, and/or pumping systems that introduce additional mechanical and operational complexities and expenses. Blending has significant downsides and is neither a cost-effective nor available option for hexavalent chromium mitigation in many areas. Further, many view blending as a sub-optimal use of low-chromium water.

Other conventional solutions for chromium mitigation include water removal systems. A significant downside of conventional water removal systems (e.g., reverse osmosis, distillation) is a steady byproduct of concentrated brine, often referred to as a reject stream. Although some jurisdictions permit discharge of reject streams as industrial effluent, a growing number require controlled disposal because local wastewater treatment facilities may not be suitably equipped to treat water having total dissolved solids (TDS) exceeding a locally or nationally defined threshold.

Further, water removal systems serve to concentrate all contaminants, not just chromium. In some circumstances, even if a reject stream has a suitable TDS and/or a suitable chromium level to otherwise be processed at a wastewater treatment facility as permitted industrial effluent, that stream may nevertheless have a concentration of another contaminant that exceeds a different threshold, disqualifying the reject stream from disposal as industrial effluent.

In such circumstances, controlled disposal is required which can be expensive, may involve toxic or caustic material handling capability, and may be mechanically and operationally complex. Moreover, many conventional water removal systems (such as reverse osmosis systems) exhibit low water recovery efficiency. As an example, the most performant utility scale reverse osmosis systems often recover only up to seventy percent of water from an untreated volume, leaving unrecovered water hydrating the reject brine. Because of this inefficiency, utility scale water treatment facilities with chromium removal capability require an exceptionally large footprint in order to maintain required output volume. Large footprint facilities are not readily constructable or operable at all sites requiring hexavalent chromium mitigation of water sources.

Conventional filtration techniques include membrane filtration and flocculation/coagulation. In both cases, however, high-cost filter and filter membranes must be regularly backwashed, replaced, or otherwise cleaned, increasing cost and downtime and decreasing throughput. In many cases, such as with flocculation, dangerous chemicals are required as consumable inputs.

Microbial degradation of Cr(VI) can result in unsuitably high concentrations of Cr(III). Further, it is often challenging to maintain conditions suitable for microbial populations to thrive while providing a consistent reduction of Cr(VI) to Cr(III).

Nanomaterial adsorption, an example of which is activated carbon, provides a filter media with extremely high surface area to encourage adsorption of dissolved heavy metal, including Cr(III) and Cr(VI). However, adsorption techniques for filtering chromium are not suitable for many water volumes or head pressures. Further, adsorption techniques typically require replacement of filter media (in lieu of backwashing) and are thus not suitable in all circumstances.

In view of the foregoing, it may be appreciated that generally and broadly, conventional chromium removal systems are often expensive to install and operate, require significant space, power, and regular skilled maintenance (or are significantly throughput-constrained), and productive of dangerous waste byproducts.

Embodiments described herein relate to mobile/movable chromium mitigation systems that are deliverable to a site, and are configurable to any number of suitable service volumes. In particular, embodiments described herein include a trailer, container, or other housing into which a Cr(III) precipitation system is installed and configured to support a filtration volume of a particular installation site. Specifically, the container receives, as input, a supply of contaminated water and an electrical power supply and provides as output (at the same or substantially the same head pressure) a filtered water supply.

Within the container is disposed a pressurized, pumpless water filtration system that includes a reduction stage for chemically reducing Cr(VI) to Cr(III), an oxidation stage for oxidizing Cr(III), a precipitation stage to permit oxidized Cr(III) to crash out of solution, and a set of post-reaction filters (simply, “post” filters) to separate particulate matter (such as precipitated Cr(III) from the water supply. Thereafter, one or more appropriate additives (e.g., chlorine, fluoridation, minerals for taste) can be introduced to the particulate filtered water before being provided as utility water at an output defined through the container.

In many embodiments, the container includes multiple post filters operating in parallel such that a single post filter can be backwashed at a regular interval with water output from the other post filters.

For example, a water source may provide output at a flow rate of 800 gpm. In this example, five post filters can be used, each configured for a maximum flow rate of 250 gpm. When all five post filters are in service and operating, each filter operates well below maximum flow rate at 160 gpm. If a single filter requires backwashing (e.g., a scheduled interval has expired, differential pressure sensing indicates fouling, or a manual backwash signal received from an operator), that filter can be decoupled from output and input by operation of one or more mechanized valves and associated plumbing, thereby increasing the duty of each remaining filter by 25% to 200 gpm, still below maximum flow rate of each filter.

In this example, a portion of the 800 gpm output of the group of four in-service post filters is temporarily diverted to the output of the backwash mode filter, so as to backwash that filter at a rate and for a duration appropriate to circumstances.

For example, the filter may be backwashed at a higher rate than the operating rate of the filter, such as 300 gpm or 400 gpm. In many cases, a maximum backwash rate and/or backwash duration may depend on filter media, filter media depth, headroom for expansion of the filter bed during backwashing and so on. Continuing the preceding example, if the offline post filter is backwashed at 300 gpm, net output of the water filtration system may be temporarily reduced to 500 gpm until backwashing is complete.

Thereafter, the now washed filter can be returned to service and another filter can be scheduled for backwashing. In this manner, each of the five post filters (in this example, in others more or fewer filters may be suitable) can be automatically backwashed without requiring a separate backwash water source or a separate backwash pump. More simply, both filtration and automated backwashing can be “powered” by head pressure of the water source itself.

In many cases, backwashing of a post filter may proceed for 5-10 minutes, a number that may vary from embodiment to embodiment or site to site. In an example including five post filters, an interval of 25-50 minutes may be required to backwash all filters in sequence. This process may be completed during off-peak demand hours such that water demand is not impacted by reduced flow rates required for self-backwashing as described herein. Continuing the example above, output of the system may be 800 gpm for 23.5 hours per day, and 500 gpm for only 0.5 hour during backwashing of all five filters.

In some embodiments, a container can include a storage tank or storage volume that accumulates and/or buffers water output of the system such that backwashing intervals do not result in reduced output of the system overall. For example, in some cases, a storage tank may have a 1500 gal capacity.

As a result of this construction, during normal operation, the storage tank receives input at 800 gpm (all five filters in service) and provides output at 790 gpm, accumulating roughly 10 gpm until the tank is full after which the flow rate can increase to 800 gpm. During backwashing of a single filter, input to the tank drops as noted above to 500 gpm. In this example, the water stored in the 1500 gallon storage tank discharges at 290 gpm to accommodate the gpm diversion required for backwashing. As understood by a person of skill in the art, the storage tank in this example can sustain the 790 gpm output (500 gpm input+290 gpm reserve) for roughly 5.17 minutes before being entirely depleted, exceeding the required five minute interval for backwashing.

Thereafter, the storage tank may be filled again at a rate of 10 gpm, or over 2.5 hrs. During this 2.5 hr period, output from the tank may be 790 gpm. After the tank is full, output increases to 800 gpm until backwashing is next required (which may be once every 4 hrs and 48 minutes for five filters, evenly spread throughout a 24 hour period). In this construction, output from the system transitions between 800 gpm and 790 gpm every roughly 2.5 hrs. Thus, output from the system is substantially consistent, while still accommodating automatic backwashing of filters.

Of course, in some embodiments, larger storage tanks may be included that can enable a larger time buffer to connect and disconnect backwash configuration plumbing. For example, a 3000 gallon tank can accommodate a consistent 800 gpm discharge rate over the course of a 24 hour period.

In yet other embodiments, the storage tank can be used as a source of water for backwashing. In these constructions, water can be pumped from the discharge tank to a sufficient flow rate to backwash a given filter. A person of skill in the art may appreciate that many configurations are possible, and different site requirements may necessitate different configurations of a system as described herein. Variables for consideration include, but are not limited to: number of post filters; size of post filters; size or reaction volumes; fouling rates; flow rate; head pressure; Cr(VI) concentration at source; Cr(III) concentration at source; and so on. System design considerations vary from embodiment to embodiment and site to site.

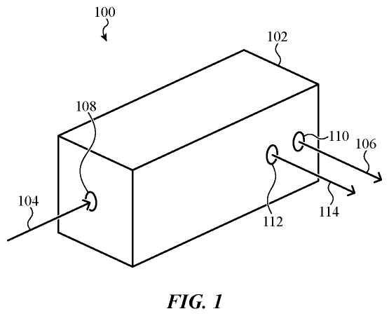

These foregoing and other embodiments are discussed below with reference to FIGS. 1-4. However, those skilled in the art will readily appreciate that the detailed description given herein with respect to these figures is for explanation only and should not be construed as limiting.

FIG. 1 depicts a simplified system diagram of a self-contained hexavalent chromium mitigation system, as described herein. The hexavalent chromium mitigation system can be configured at, and/or deployed to, a number of suitable sites at which source water, whether ground water or surface water, contains undesirably high levels of chromium, requiring reduction to a lower level referred to herein as a target chromium level. In many cases, target chromium levels may be below detectability or may be below EPA standard MCL for drinking water or other purposes.

In other cases, target chromium levels may be selected for a specific intended purpose, such as for an industrial purpose, for reintroduction to surface water, for discharge as effluent to a waste treatment facility, or the like. In other examples, a system as described herein can be operated as a prefilter to another conventional water filtration system.

In view of the foregoing, generally and broadly, a person of skill in the art may appreciate that different chromium levels can be targeted given different circumstances. For simplicity of description, the embodiments that follow contemplate a deployment in which a self-contained hexavalent chromium mitigation system is configured to provide potable water as output; this is merely one example hexavalent chromium mitigation purpose for which a system as described herein can be configured.

For simplicity of description, the embodiments that follow presume a groundwater source, but this may not be required of all embodiments. In non-groundwater embodiments, an input pump may be required to establish appropriate pressure and/or flow rates. As an example, a surface water source such as a reservoir may be at least partially filtered of chromium by operation of a system as described herein. In such examples, the system may be configured to discharge back into the reservoir or into another location.

As noted above, a hexavalent chromium mitigation system can be configured to filter a ground water source, such as a well, to output water suitable for drinking. In many configurations, a hexavalent chromium mitigation system as described herein may include two or more distinct hexavalent chromium mitigation water treatment chains operating in parallel and/or in a switch-over or fail-over configuration such that if one hexavalent chromium mitigation treatment chain fails or is off-lined for maintenance, hexavalent chromium mitigation of water can continue uninterrupted. A person of skill in the art understands that many configurations are possible. For simplicity of description, the embodiments that follow reference a single chain, but it is appreciated that this is merely one example configuration.

Generally and broadly, one or more hexavalent chromium mitigation treatment chains receive input water from a water source, the “source,” and provide output at an “outlet.” In many constructions, head pressure at the source is approximately equal to head pressure at the outlet. Differential pressure sensing can be used to inform one or more controllers or electronic control systems of system performance, although this is not required of all embodiments. Generally and broadly, for embodiments described herein, pressure drop from the source to the outlet may be negligible; inflow pressure and outflow pressure and/or flow rate(s) may be substantially similar.

In view of these constructions, it may be appreciated that for embodiments described herein, head pressure can be used as a motivating force to transit water through various stages of chromium filtration such as described herein.

As noted above, the source may be a source of untreated water having an undesirable chromium concentration, whether that concentration is in the form of Cr(III) or Cr(VI). The hexavalent chromium mitigation treatment chains receive untreated water from the source via appropriate plumbing that can be split among multiple paths to direct untreated water to one or more self-contained water treatment facilities, such as described herein.

The self-contained water treatment facility 100 includes a container housing 102, which may be a trailer, shipping container (e.g., ISO standard), equipment cabinet/housing, or any other suitable constructed housing. The container housing 102 can be manufactured from any suitable material or combination of materials including metals, wood, plastics, acrylics, and the like or any combination thereof.

The container housing 102 can be sized to include space and/or access panels or doorways for use by an operator or service technician, but this is not required of all embodiments and is omitted from FIG. 1 for simplicity of illustration. In many constructions the container housing 102 is manufactured off-site and delivered to a water treatment site, but this is also not required of all embodiments.

The container housing 102 can exhibit ISO dimensions for shipping containers or mobile office trailers and the like. Sizes for the container housing 102 can vary from embodiments to embodiment and site to site.

The self-contained water treatment facility 100 receives water to be treated from a chromium-rich water source 104 and provides a potable water output 106. The chromium-rich water source 104 is received at an input port 108 and the potable water output 106 is provided at an output port 110. Couplings associated with the input port 108 and the output port 110 can vary from embodiment to embodiment, and may vary in size based on site requirements.

As noted above, the self-contained water treatment facility 100 is configured to filter chromium from the chromium-rich water source 104. Chromium mitigation is performed within the container housing 102 by reducing hexavalent chromium to trivalent chromium by injecting a quantity of ferrous chloride, ferrous sulphate, or another reducing agent with iron. A person of skill in the art may appreciate that reaction time may be on the order of minutes; as a result, a reaction volume size may depend on the flow rate of water from the chromium-rich water source 104. More particularly, a reduction reaction can take place within a pipeline or a reaction tank, suitably sized such that water within the reduction reaction volume is within the reaction volume for at least enough time to reduce substantially all hexavalent chromium to trivalent chromium.

As a simple example, the chromium-rich water source 104 may provide water at 10 gpm at a 3″ ID (inner diameter) input pipeline. This water from the chromium-rich water source 104 may be contaminated a hexavalent chromium concentration requiring 3 minutes of reaction time given a particular dose of reducing agent (e.g., ferrous chloride, ferrous sulfide, and so on). A person of skill in the art understands that a pipeline interior to the self-contained water treatment facility 100 may have a number of suitable diameters. As diameter increases, the length of pipe required decreases and vice versa. A length of pipe and a diameter thereof suitable to provide a reaction time of 3 minutes (or other times) will vary from embodiment to embodiment.

Once within the reaction volume, the Cr(VI) begins reducing to Cr(III). After reduction, Cr(III)-rich water can be injected with an oxidizing agent to cause the hexavalent chromium and iron oxide to coprecipitate. In some cases, oxidation can be facilitated by increasing dissolved oxygen (DO) via a venturi injector or other suitable apparatus. In other cases, a chemical oxidizing agent such as chlorine can be introduced to the stream. Once oxidized, the trivalent chromium will coprecipitate with iron oxide from solution and thereafter can be filtered by a post filter or a parallel array of post filters, such as described above.

Periodically, the post filters may be backwashed as described above by diverting part of the output stream, the potable water output 106, through one or more post filters arranged/plumbed for backwashing. Output of the backwash can be stored or output via the backwash effluent port 112 as the backwash output 114.

In some cases the backwash output 114 can be further filtered or provided as input to a water recovery system, such as a reverse osmosis system or a distillation system. This is not required of all embodiments.

It may be appreciated that within the container housing 102 can be included one or more controllers or electronic devices that perform, coordinate, or otherwise execute one or more control operation of the self-contained water treatment facility 100. For simple reference, such electronics and systems can be collectively referred to as a central controller.

The central controller can be any suitable electronic device configured to interoperate with one or more electronically-controllable dosing modules and/or one or more sensors associated with one or more of the modules of the hexavalent chromium mitigation treatment chains.

For example, the central controller can be communicably coupled to a chromium sensor (e.g., UV spectrophotometer) disposed within a sampling port interposing the source and later stages of chromium mitigation treatment chains of the self-contained water treatment facility. The central controller can likewise be communicably coupled to a second (or further) chromium sensor(s) disposed within a sampling port interposing reduction reaction tanks and/or pipelines and the oxidation reaction tanks and/or pipelines.

In a configuration in which two sensors are disposed at the input port 108 and the output port 110 respectively, each can be sampled by the central controller on an interval or in another suitable manner to determine hexavalent chromium mitigation performance of the reduction reaction tanks and/or pipelines. More simply, the central controller can be configured to compare chromium concentration at the input of the reduction reaction tanks and/or pipelines and chromium concentration at the output of the reduction reaction tanks and/or pipelines to determine real-time hexavalent chromium mitigation performance of the hexavalent to trivalent reduction reaction.

In addition, the central controller can be operably coupled to one or more electronically-controllable dosing modules, each configured to incrementally add one or more volumes of material into the reduction reaction tanks and/or pipelines. For example, a first electronically-controllable dosing module can be configured to add a volume or quantity of reduction agent in response to an instruction issued by the central controller. A second electronically-controllable dosing module can be configured to add a volume or quantity of oxidizing agent in response to an instruction issued by the central controller.

In many cases, the electronically-controllable dosing modules can be configured to dose a fixed quantity of material at a fixed interval. For example, a certain quantity of reduction agent is dosed by an electronically-controllable dosing module every 60 seconds, whereas a different quantity of oxidizing agent is dosed by another electronically-controllable dosing module every 60 minutes. These examples are not exhaustive; any suitable interval and/or volume of dose is possible. In some constructions, the central controller may be configured to issue a command to change an interval and/or a volume dosed by a particular electronically-controllable dosing module.

For example, in some constructions, the central controller can be configured to issue a command in the form of a structured data object including two attributes, a volume and an interval. As an example, the structured data object can conform to a defined format such as XML or JSON. As an example, a structured data object transmitted by the central controller to an electronically-controllable dosing module may conform to the JSON format. An example follows:
{
   “vol_ml”: 15,
   “dose_interval_s”: 60
}

In this example, the central controller instructs the electronically-controllable dosing module to dose a particular material, such as reduction agent or phosphorous, at a volume of 15 ml every 60 seconds. As may be appreciated the frequency of doping and/or doping volume will be implementation specific.

In some cases, the central controller can be configured to issue a temporary instruction, such as an instruction to increase dose volume for a period of N minutes. In other cases, an instruction can durably change configuration of the electronically-controllable dosing module such that until a next command is received.

The controller can likewise schedule and coordinate and/or orchestrate backwashing of each respective post filter of the sets of post filters of the self-contained water treatment facility 100. As noted above, the central controller can be configured to monitor one or more timers or event streams through which the central controller may be periodically triggered to initiated backwashing of a particular post filter. During a backwash operation, the central controller may instruct an output valve of a post filter to close, and/or a diverter valve to open to divert the output of the selected post filter to receive, as input, output of the remaining in-service post filters. The central controller can also be configured at a suitable time instruct a controllable valve at the input of the selected post filter to operably couple to the backwash effluent port 112. After a suitable period of time, the central controller can return each controlled valve to a starting position, returning the selected post filter to service.

The foregoing example is merely one configuration. It may be appreciated that in other constructions, a controller and electronically-controllable dosing module can be configured for serial communication or another communication protocol or standard. In other cases, the electronically-controllable dosing module may not include control electronics at all—in such examples, the central controller can be configured to control a relay or contactor that causes an electronic element, actuator, or the like within the electronically-controllable dosing module to actuate and dose a particular volume into the reduction reaction tanks and/or pipelines.

Further to the foregoing, it may be appreciated that the central controller can be implemented in a number of suitable ways. In some cases, the central controller can be a programmable logic controller. In others, the controller may be a more general purpose computing resource configured to instantiate one or more instances of control software each of which may be configured to interface with one or more electronically-controllable doping modules as described herein or with one or more sensors as described herein. In these examples, the central controller can include a processor and a memory.

The memory can be configured to store one or more executable instructions that, when accessed by the processor cause to be instantiated at least partially within the memory an instance of software configured to perform, coordinate, or monitor one or more tasks associated with operation of the self-contained hexavalent chromium mitigation system. In some cases, although not required of all embodiments, the central controller can include a network communications module and in some cases a display. The network communications module can enable remote command and control and monitoring of the central controller, and the display can be configured to render a graphical user interface conveying information in respect of operation and/or state of the hexavalent chromium mitigation system.

As noted above, the network communications module can support remote access to the central controller. For example, the central controller can be, in some embodiments, communicably coupled to a client device. The client device can be any suitable portable or stationary electronic device. Examples include cellular phones, desktop computers, laptop computers, industrial control appliances, programmable logic controllers, and so on.

The client device can include a processor, a memory, a network communications module and/or a display. These components can cooperate to instantiate an instance of frontend software configured to provide an interface for an operator of the device to issue commands to the central controller to change one or more operational parameters of the hexavalent chromium mitigation system.

These foregoing embodiments depicted in FIG. 1 and the various alternatives thereof and variations thereto are presented, generally, for purposes of explanation, and to facilitate an understanding of various configurations and constructions of a water hexavalent chromium mitigation system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, it may be appreciated that a central controller can be configured to manage or control some, but not all, operations of a hexavalent chromium mitigation as described herein. In some cases, a central controller may not be required, and mechanical control may be possible. In other cases, manual control of dosing and/or reaction times may be suitable. May configurations are possible.

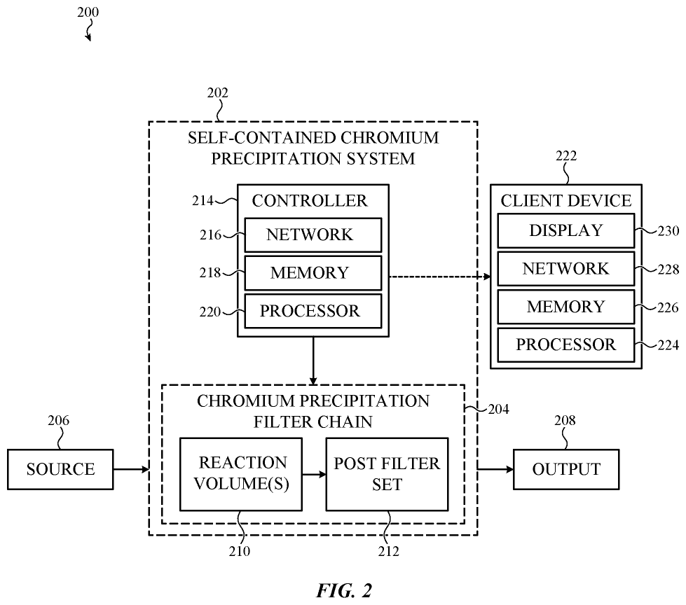

FIG. 2 depicts a simplified schematic control diagram of a hexavalent chromium mitigation system as described herein. Specifically, the self-contained chromium precipitation system 200 includes, as with other embodiments described herein, an enclosure 202 that can be made from any number of suitable materials including metal, plastic, acrylic, wood, or another suitable structural material or combination of materials.

The enclosure 202 houses and supports a precipitation filter chain 204 that receives input water from an input pipeline 206 and provides output water via an output pipeline 208. The input pipeline 206 carries chromium-rich water having elevated levels of Cr(VI). The output pipeline 208 carries away from the self-contained chromium precipitation system 200 water having a reduced chromium concentration. In many cases, chromium concentration within the output pipeline 208 is below EPA standard MCL. In other embodiments or installations, chromium concentration within the output pipeline 208 is undetectable. In other cases, chromium concentration is above EPA standard MCL for potability, but is reduced from the input pipeline 206 (e.g., for industrial non-consumption purposes).

As with other embodiments described herein, the precipitation filter chain 204 includes a series of reaction volumes 210 and a post filter set 212. The series of reaction volumes 210 includes a reduction reaction volume preceding a precipitation volume. The reduction reaction volume can follow injection of a reducing agent, such as iron sulfate. In this construction, the reduction reaction volume facilitates reduction of Cr(VI) to Cr(III). Thereafter, an oxidizer can be injected (e.g., DO injection via venturi injector to prevent/mitigate cavitation) preceding a precipitation volume in which Cr(III) and iron oxide coprecipitate. Finally, water within the precipitation volume is passed to the post filter set 212 which can leverage a filter media such as manganese dioxide to capture the precipitate. Filtered output of the post filter set 212 is plumbed to the output pipeline 208.

The operation of the precipitation filter chain 204 can be substantially automatic and controlled and monitored by operation of the central controller 214. The central controller 214 can be configured to communicate with one or more devices (e.g., mechanical additive injectors, valves, and other water movement or conditioning systems) over a network, facilitated by a network coupling 216. The network coupling 216 can be configured for TCP communications or other conventional network-based communication protocol, or may be configured for serial communication with one or more controllable devices. A person of skill in the art may readily appreciate that many devices can be coupled to the central controller 214 via one or more network types with which the network coupling 216 can communicate. In some cases, the network coupling 216 includes a wireless and/or cellular modem for communicating to external networks so as to provide telemetry and/or operational information and/or to receive remote control information.

The central controller 214 also includes a memory 218 and a processor 220. The processor 220 and the memory 218 can be configured to cooperate to instantiate an instance of control software that executes one or more control operations in respect of operation of the self-contained chromium precipitation system 200. For example, the control software may be configured to control a dosing schedule of the reducing agent, may be configured to control a dosing schedule of the oxidizer, and/or may be configured to control a dosing schedule of another additive, such as a fluoridation injection system interposing the post filter set 212 and the output pipeline 208.

The control software can likewise control backflow operations of the post filter set 212. As described above, the control software can select (e.g., on a schedule, at a particular interval, in response to a command, or in response to a sensor input such as a differential pressure sensor exceeding a threshold pressure difference from an input of a post filter to an output of a post filter) a time at which to reconfigure water routing within the self-contained chromium precipitation system 200 to divert a portion of the water output via the output pipeline 208 to backwash a particular post filter or two or more post filters for a period of time. As noted above, the control software can be configured to control one or more valves and/or one or more diverters. Once an appropriate time interval has elapsed, the control software can be configured to reverse the process, coupling the selected post filter back into service with other filters of the post filter set 212.

The control software instantiated by cooperation of the memory 218 and the processor 220 can be additionally configured to monitor operation of the precipitation filter chain 204 to determine whether adjustments should be made to augment operation thereof. For example, by leveraging a chromium concentration sensor interposing the post filter set 212 and the output pipeline 208, the control software may determine combined performance of the series of reaction volumes 210 and the post filter set 212. In response to a higher than expected chromium value, the control software may increase dosing of reduction agent, either incrementally or for a specified period of time. In some case, the control software may additionally increase concentration of dissolved oxygen or another oxidizing agent. In yet further embodiments, the control software may instruct one or more valves to partially or entirely close so as to regulate flow, thereby increasing reaction time and precipitation time.

In other cases, in response to a lower than expected chromium value the control software may reduce concentrations of oxidizer and/or reducing agent and/or may increase output flow rate. In these cases, operation of the control software may serve to conserve consumables (e.g., reducing agents, oxidizers) useful to the operation of the self-contained chromium precipitation system 200.

In some cases, the control software operating over resources of the central controller 214 can be configured to instruct a servicing interval for the filter media (e.g., manganese dioxide) within the post filter set 212. For example, the control software may periodically schedule an infusion of a strong oxidizer such as chlorine into a post filter to effectively “recharge” said filter media. The infusion of oxidizer can be provided for a period of time dependent upon media depth and/or filter volume and/or oxidizer concentration. After an appropriate period has elapsed, a backwashing operation may be performed to remove remaining oxidizer from that respective post filter.

In some cases, the central controller 214 can be remotely controlled from a client device 222. For example, the client device 222 can be configured to communicably couple to the central controller 214 via the network coupling 216. In other cases, the client device 222 communicates with the central controller 214 over a secure connection over the open internet and/or over a private network. The client device 222 can include a processor 224, a memory 226, a network coupling 228 and a display 230 all of which can cooperate to instantiate an instance of client software configured to communicably couple to the central controller 214 and/or to render a graphical user interface over the display 230 that receives instructions from an operator handling the client device 222 and/or presents information to the operator including telemetry information and/or operational/status information. From the client device 222, the operator can control operation of the self-contained chromium precipitation system 200 whether the operator is within the enclosure 202 or in a remote location. Example client devices include, but are not limited to: cellular phones; laptop devices; tablet devices; desktop computing devices; industrial control devices; and so on.

These foregoing embodiments depicted in FIG. 2 and the various alternatives thereof and variations thereto are presented, generally, for purposes of explanation, and to facilitate an understanding of various configurations and constructions of a water hexavalent chromium mitigation system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

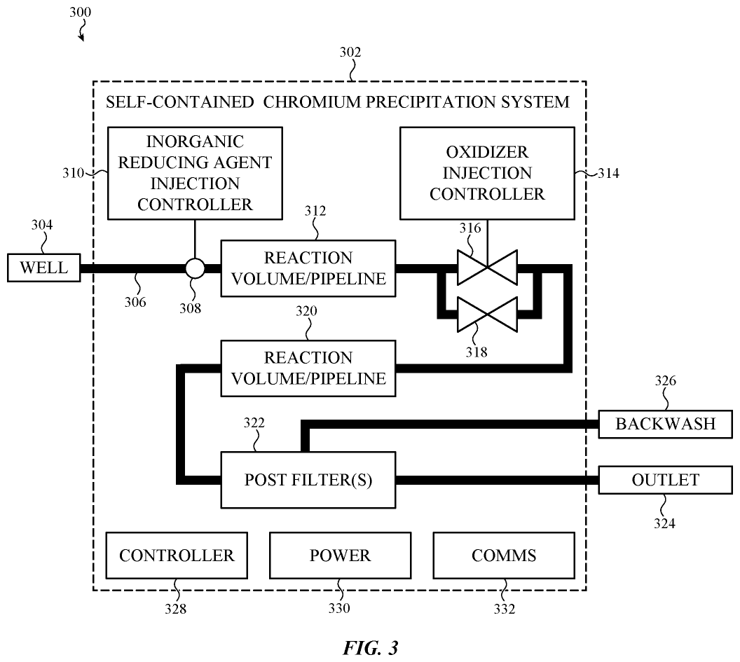

FIG. 3 depicts a simplified schematic flow diagram of a self-contained hexavalent chromium mitigation system as described herein. The self-contained chromium precipitation system 300, as with other embodiments described herein, is disposed substantially entirely within a container 302 that may be formed from any number of suitable materials or combinations of materials.

The self-contained chromium precipitation system 300 receives chromium rich water from a source, such as a well-water source 304, which can be received through an aperture in the container 302 within an input pipeline 306.

A dosing and/or injection port, the dosing port 308, can be inserted into the input pipeline 306 so as to enable an inorganic reducing agent injection controller 310 to controllably inject an iron-based reducing agent, such as ferrous chloride or ferrous sulfate, into the input pipeline 306. Once the chromium rich water from the well-water source 304 has been dosed by the inorganic reducing agent injection controller 310 via the dosing port 308, the dosed water can enter the reduction reaction volume 312, which may be a serpentine stretch of pipeline and/or a reaction tank.

The total volume of the tank or the pipeline that defines the reduction reaction volume 312 can be selected such that that at a given flow rate (which may be the same or different from a flow rate of the well-water source 304) dosed chromium rich water has time to suitably react or, more particularly, that Cr(VII) dissolved in the water may be reduced to Cr(III). More simply, a volume or size of the reduction reaction volume 312 can be selected to support a particular selected reduction reaction time based on a target or given flow rate. The higher the flow rate, the larger the volume of the reduction reaction volume 312.

Thereafter, water can exit the reduction reaction volume 312 and an oxidizer can be injected via an oxidizer injection controller 314 into a venturi injector 316 or other similar injection port or dosing port. Pressure changes and/or flow rate changes that may be introduced by operation of the venturi injector 316 can be balanced by suitable flow control plumbing, such as the flow control plumbing 318.

Once an oxidizer is injected into the stream, the oxidized, Cr(III)-rich water can be provided as input to an oxidation reaction volume 320, in which iron oxide and Cr(III) can co-precipitate and crash out of solution. As with the reduction reaction volume 312, the size and/or shape of the oxidation reaction volume 320 can vary from embodiment to embodiment and may be selected to facilitate a suitable oxidation reaction time. In other words, a size of the reduction reaction volume 312 can be based at least in part on a target or selected oxidation reaction time based on a flow rate from well-water source 304. In some cases, pipeline segment can be selectively plumbed into or out of circuit with the oxidation reaction volume 320 (and/or the reduction reaction volume 312) so as to dynamically increase or decrease reaction volume as needed.

Thereafter, output of the oxidation reaction volume 320 can be plumbed to an input of a post filter set, the post filter set 322. Each post filter can have a filter depth of filter media configured to arrest precipitates, including Cr(III) and iron oxide. An example filter media is manganese dioxide, but this is merely one example; in other cases, other filter media may be preferred. In some cases, all post filters of the post filter set 322 can include the same filter media, whereas in others different post filters can have different and/or nonuniform filter media.

As with other embodiments described herein, the post filter set 322 can be configured to provide filtered water output to an outlet, illustrated as the service outlet 324. Interposing the post filter set 322 and the service outlet 324 may be another injector or doser to add additional solutes either for health, safety, or taste purposes (e.g., chlorination, fluorination, mineralization, and so on).

The post filters of the post filter set 322 can be backwashed at intervals using water diverted from the service outlet 324, as described above. Backwash effluent can be output via the backwash outlet 326.

The self-contained chromium precipitation system 300 can also include a central controller 328, a power source 330, and a communications system 332. The central controller 328 can be operably coupled to the inorganic reducing agent injection controller 310, the oxidizer injection controller 314, and/or one or more chromium or other sensors which may be coupled to any appropriate sensing port throughout the self-contained chromium precipitation system 300. The central controller 328 can be additionally coupled to one or more valves (e.g., for backwash and/or reaction volume dynamic adjustment) or other mechanical elements within the self-contained chromium precipitation system 300 that may be required or desired for a particular embodiment.

The central controller 328 can receive operational power from the power source 330, which may be an internal power source (e.g., battery, generator, solar array, and the like) or an external power source/coupling.

As noted above, the self-contained chromium precipitation system 300 also includes the communications system 332, which can provide a network coupling for the central controller 328. The communications system 332 may be cellular, Wi-Fi, Ethernet, satellite or other suitable network component or combination of components.

These foregoing embodiments depicted in FIGS. 2-3 and the various alternatives thereof and variations thereto are presented, generally, for purposes of explanation, and to facilitate an understanding of various configurations and constructions of a water hexavalent chromium mitigation system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

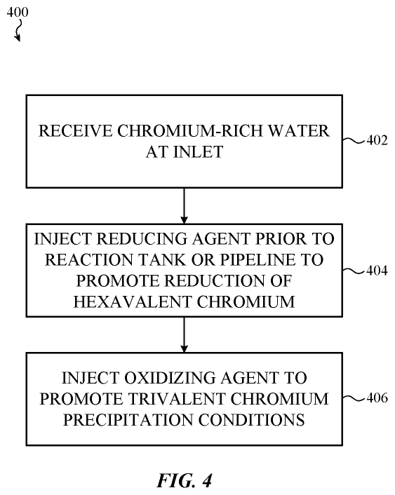

FIG. 4 depicts a flow chart corresponding to example operations of a method of hexavalent chromium mitigation, as described herein.

The method 400 includes operation 402 at which chromium-rich water is received at an inlet of a self-contained mitigation system, as described herein. At operation 404, a reducing agent is injected prior to a reduction reaction tank or pipeline volume. Thereafter at operation 406, an oxidizing agent can be injected so as to promote conditions that encourage trivalent chromium to coprecipitate with iron oxide. Thereafter, one or more post filters can be used to arrest precipitates and provide filtered water as output.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A water filtration system comprising:
an enclosure;
an inlet to receive input water from a water source at a flow rate;
a reducing agent injection controller within the enclosure and configured to dose a reducing agent into the input water;
a first reaction volume within the enclosure and configured to receive the input water dosed with the reducing agent, the first reaction volume supporting a selected reduction reaction time at the flow rate;
an oxidation agent injection controller within the enclosure and configured to dose an oxidizing agent into water output from the first reaction volume;
a second reaction volume within the enclosure and configured to receive the water output from the first reaction volume dosed with the oxidizing agent, the second reaction volume supporting a selected oxidation reaction time at the flow rate;
an array of post filters within the enclosure and coupled to an outlet of the second reaction volume, the array of post filters comprising a filter media configured to, at least one of:
arrest precipitated trivalent chromium; or
adsorb dissolved trivalent chromium; and
an outlet extending at least partially through the housing and coupled to an output of the array of post filters.

2. The water filtration system of claim 1, wherein the first reaction volume comprises a serpentine arrangement of water pipeline.

3. The water filtration system of claim 1, wherein the water source is a chromium contaminated water source.

4. The water filtration system of claim 1, comprising a central controller within the enclosure, the central controller communicably coupled to the reducing agent injection controller and to the oxidation agent injection controller.

5. The water filtration system of claim 1, wherein the oxidation agent injection controller comprises a venturi injector.

6. The water filtration system of claim 1, wherein the oxidizing agent comprises oxygen.

7. The water filtration system of claim 1, wherein the oxidizing agent comprises chorine.

8. The water filtration system of claim 1, wherein the reducing agent comprises iron.

9. The water filtration system of claim 1, wherein the reducing agent is configured to reduce hexavalent chromium to trivalent chromium.

10. The water filtration system of claim 1, wherein the reducing agent comprises iron.

11. A method of filtering chromium rich water, the method comprising:
receiving chromium rich water at an inlet, the chromium rich water received at a flow rate;
dosing the chromium rich water with a reducing agent;
providing the reducing agent-dosed water as input to a first reaction volume, the first reaction volume having a first size supporting a selected reduction reaction time at the flow rate;
dosing water output from the first reaction volume with an oxidizing agent;
providing the oxidizing agent-dosed water as input to a second reaction volume, the second reaction volume having a second size supporting a selected oxidation reaction time at the flow rate;
providing output of the second reaction volume as input to an array of post filters comprising a filter media configured to arrest precipitated trivalent chromium or to adsorb dissolved trivalent chromium; and
providing output of the array of post filters as a filtered water output.

12. The method of claim 11, wherein the reducing agent comprises ferrous chloride or ferrous sulphate.

13. The method of claim 11, wherein dosing water output form the first reaction volume with the oxidizing agent comprising injecting oxygen via a venturi injector.

14. The method of claim 11, wherein the array of post filters are configured to be backwashed with the filtered water output.

15. The method of claim 11, wherein the filter media comprises manganese dioxide.

16. The method of claim 11, wherein the chromium rich water comprises hexavalent chromium and trivalent chromium.

17. A water filtration system comprising:
an enclosure;
an inlet to receive input water from a chromium rich water source at a flow rate;
a first injector within the enclosure and configured to dose a reducing agent into the input water;
a first reaction volume within the enclosure and configured to receive the input water dosed with the reducing agent;
a second injector within the enclosure and configured to dose an oxidizing agent into water output from the first reaction volume;
a second reaction volume within the enclosure and configured to receive the water output from the first reaction volume dosed with the oxidizing agent;
a post filter within the enclosure and coupled to an outlet of the second reaction volume, the post filter comprising a filter media configured to, at least one of:
arrest precipitated trivalent chromium; or
adsorb dissolved trivalent chromium; and
an outlet extending at least partially through the housing and coupled to an output of the post filter.

18. The water filtration system of claim 1, wherein the enclosure is installed local to the chromium rich water source.

19. The water filtration system of claim 1, wherein the chromium rich water source is a well water source.

20. The water filtration system of claim 1, wherein the first reaction volume and the second reaction volume each comprises a length of pipeline, disposed within the enclosure.
